(19) United States
(12) Patent Application Publication
(10) Pub. No.: US 2010/0075677 A1
(43) Pub. Date: Mar. 25, 2010

(54) METHODS AND SYSTEMS FOR SELECTING A TARGET BS WITH THE BEST SERVICE SUPPORTED IN WIMAX HANDOVER

(75) Inventors: Yu Wang, San Diego, CA (US); Guangming Carl Shi, San Diego, CA (US); Tom Chin, San Diego, CA (US)

Correspondence Address: QUALCOMM INCORPORATED, 5775 MOREHOUSE DR., SAN DIEGO, CA, 92121, US

(73) Assignee: QALCOMM Incorporated, San Diego, CA (US)

(21) Appl. No.: 12/235,546

(22) Filed: Sep. 22, 2008

(51) Int. Cl. H04W 36/00

(52) U.S. Cl. 455/436

(57) ABSTRACT

Methods and apparatus for notifying a mobile station (MS) of service flow parameters supported by neighbor base stations, such that the MS may select a suitable neighbor base station (BS) candidate (i.e., a target BS) for performing a handover are provided. The notification may occur via handover messages, such as a BS Handover Request (MOB_BSHO-REQ) message or a BS Handover Response (MOB_BSHO-RSP) message, with a Service Level Supported field added, indicating the service flow parameters supported by the neighbor BSs. In this manner, service quality levels of data exchanges may be maintained as an MS is handed over from one BS to another.

### TECHNICAL FIELD

Certain embodiments of the present disclosure generally relate to wireless communications and, more particularly, to maintaining service quality levels of data exchanges as a mobile station (MS) is handed over from one base station (BS) to another.

### BACKGROUND

Orthogonal frequency-division multiplexing (OFDM) and orthogonal frequency division multiple access (OFDMA) wireless communication systems under IEEE 802.16 use a network of base stations to communicate with wireless devices (i.e., mobile stations) registered for services in the systems based on the orthogonality of frequencies of multiple subcarriers and can be implemented to achieve a number of technical advantages for wideband wireless communications, such as resistance to multipath fading and interference. Each base station (BS) emits and receives radio frequency (RF) signals that convey data to and from the mobile stations.

For various reasons, such as a mobile station (MS) moving away from the area covered by one base station and entering the area covered by another, a handover (also known as a handoff) may be performed to transfer communication services (e.g., an ongoing call or data session) from one base station to another. Three handover methods are supported in IEEE 802.16e-2005: Hard Handoff (HHO), Fast Base Station Switching (FBSS) and Macro Diversity Handover (MDHO). Of these, supporting HHO is mandatory, while FBSS and MDHO are two optional alternatives.

HHO implies an abrupt transfer of connection from one BS to another. The handover decisions may be made by the MS or the BS based on measurement results reported by the MS. The MS may periodically conduct an RF scan and measure the signal quality of neighboring base stations. The handover decision may arise, for example, from the signal strength from one cell exceeding the current cell, the MS changing location leading to signal fading or interference, or the MS requiring a higher Quality of Service (QoS). Scanning is performed during scanning intervals allocated by the BS. During these intervals, the MS is also allowed to optionally perform initial ranging and to associate with one or more neighboring base stations. Once a handover decision is made, the MS may begin synchronization with the downlink transmission of the target BS, may perform ranging if it was not done while scanning, and may then terminate the connection with the previous BS. Any undelivered Protocol Data Units (PDUs) at the BS may be retained until a timer expires.

To improve the reliability of data transmission, some wireless systems employ a hybrid automatic repeat-request (HARQ) scheme where error detection (ED) bits and forward error correction (FEC) bits are added to transmissions. A receiver can use these ED and FEC bits to determine whether or not a packet was decoded properly. If not, the receiver may signal the transmitter via a negative acknowledgment (NAK), prompting the transmitter to retransmit the packet.

### SUMMARY

Certain embodiments of the present disclosure generally relate to notifying an MS of service parameters supported by neighbor base stations (BSs), such that the mobile station may select a suitable neighbor BS candidate for performing a handover. In this manner, service quality levels of data exchanges may be maintained as a mobile station (MS) is handed over from one base station (BS) to another.

Certain embodiments of the present disclosure provide a method for indicating supported services of a neighbor BS. The method generally includes determining whether a plurality of service parameters are supported by the neighbor BS and transmitting a handover message indicating the supported service parameters for the neighbor BS.

Certain embodiments of the present disclosure provide a computer-program product for indicating supported services of a neighbor BS. The computer-program product typically comprises a computer-readable medium having instructions stored thereon, the instructions being executable by one or more processors. The instructions generally include instructions for determining whether a plurality of service parameters are supported by the neighbor BS and instructions for transmitting a handover message indicating the supported service parameters for the neighbor BS.

Certain embodiments of the present disclosure provide an apparatus for wireless communications. The apparatus generally includes means for determining whether a plurality of service parameters are supported by a neighbor BS and means for transmitting a handover message indicating the supported service parameters for the neighbor BS.

Certain embodiments of the present disclosure provide a base station. The base station generally includes logic for determining whether a plurality of service parameters are supported by a neighbor BS and a transmitter front end configured to transmit a handover message indicating the supported service parameters for the neighbor BS.

Certain embodiments of the present disclosure provide a method for determining at least one neighbor BS candidate for handover. The method generally includes receiving a handover message indicating, for each of a plurality of neighbor BSs, a plurality of service parameters that are supported by each neighbor BS; and based on the supported service parameters indicated by the handover message, selecting the at least one neighbor BS candidate for handover from the plurality of neighbor BSs in the handover message.

Certain embodiments of the present disclosure provide a computer-program product for determining at least one neighbor BS candidate for handover. The computer-program product typically comprises a computer-readable medium having instructions stored thereon, the instructions being executable by one or more processors. The instructions generally include instructions for receiving a handover message indicating, for each of a plurality of neighbor BSs, a plurality of service parameters that are supported by each neighbor BS and instructions for selecting, based on the supported service parameters indicated by the handover message, the at least one neighbor BS candidate for handover from the plurality of neighbor BSs in the handover message.

Certain embodiments of the present disclosure provide an apparatus for wireless communications. The apparatus generally includes means for receiving a handover message indicating, for each of a plurality of neighbor BSs, a plurality of service parameters that are supported by each neighbor BS and means for selecting, based on the supported service parameters indicated by the handover message, at least one neighbor BS candidate for handover from the plurality of neighbor BSs in the handover message.

Certain embodiments of the present disclosure provide a mobile device. The mobile device generally includes a receiver front end configured to receive a handover message indicating, for each of a plurality of neighbor BSs, a plurality of service parameters that are supported by each neighbor BS and logic for selecting, based on the supported service parameters indicated by the handover message, the at least one neighbor BS candidate for handover from the plurality of neighbor BSs in the handover message.

### BRIEF DESCRIPTION OF THE DRAWINGS

So that the manner in which the above recited features of the present disclosure can be understood in detail, a more particular description, briefly summarized above, may be had by reference to embodiments, some of which are illustrated in the appended drawings. It is to be noted, however, that the appended drawings illustrate only certain typical embodiments of this disclosure and are therefore not to be considered limiting of its scope, for the description may admit to other equally effective embodiments.

FIG. 1 illustrates an example wireless communication system, in accordance with certain embodiments of the present disclosure.

FIG. 2 illustrates various components that may be utilized in a wireless device, in accordance with certain embodiments of the present disclosure.

FIG. 3 illustrates an example transmitter and an example receiver that may be used within a wireless communication system that utilizes orthogonal frequency-division multiplexing and orthogonal frequency division multiple access (OFDM/OFDMA) technology, in accordance with certain embodiments of the present disclosure.

FIG. 4 is a flow diagram of example operations for notifying a mobile station (MS) of service parameters supported by a neighbor base station (BS), in accordance with certain embodiments of the present disclosure.

FIG. 4A is a block diagram of means corresponding to the example operations of FIG. 4 for notifying an MS of service parameters supported by a neighbor BS, in accordance with certain embodiments of the present disclosure.

FIG. 5 illustrates an example format of a BS Handover Request (MOB_BSHO-REQ) message with a Service Level Supported field indicating services supported by respective neighbor BSs, in accordance with certain embodiments of the present disclosure.

FIG. 6 illustrates an example format of the Service Level Supported field of FIG. 5 or FIG. 8, in accordance with certain embodiments of the present disclosure.

FIG. 7 illustrates an example format of Automatic Repeat-Request (ARQ) parameters as part of the Service Level Supported field of FIG. 6, in accordance with certain embodiments of the present disclosure.

FIG. 8 illustrates an example format of a BS Handover Response (MOB_BSHO-RSP) message with a Service Level Supported field indicating services supported by respective neighbor BSs, in accordance with certain embodiments of the present disclosure.

FIG. 9 is a flow diagram of example operations for determining, from among a group of neighbor BSs, at least one neighbor BS candidate for handover based on the service parameters supported by each neighbor BS, in accordance with certain embodiments of the present disclosure.

FIG. 9A is a block diagram of means corresponding to the example operations of FIG. 9 for determining at least one neighbor BS candidate for handover, in accordance with certain embodiments of the present disclosure.

FIGS. 10A and 10B are flow diagrams of example operations for selecting at least one neighbor BS candidate for handover based on supported service parameters, in accordance with certain embodiments of the present disclosure.

FIG. 11 illustrates an example call flow for selecting a neighbor BS candidate for handover based on supported service parameters transmitted to the MS via a MOB_BSHO-REQ message from the serving BS and performing a handover to the neighbor BS, in accordance with certain embodiments of the present disclosure.

FIG. 12 illustrates an example call flow for selecting a neighbor BS candidate for handover based on supported service parameters transmitted to the MS via a MOB_BSHO-RSP message from the serving BS in response to receiving an MS Handover Request (MOB_MSHO-REQ) message and performing a handover to the neighbor BS, in accordance with certain embodiments of the present disclosure.

### DETAILED DESCRIPTION

Certain embodiments of the present disclosure provide methods and apparatus for notifying a mobile station (MS) of service flow parameters supported by neighbor base stations, such that the MS may select a suitable neighbor base station (BS) candidate (i.e., a target BS) for performing a handover. The notification may occur via handover messages, such as a BS Handover Request (MOB_BSHO-REQ) message or a BS Handover Response (MOB_BSHO-RSP) message, with a Service Level Supported field added, indicating the service flow parameters supported by the neighbor BSs. In this manner, service quality levels of data exchanges may be maintained as an MS is handed over from one BS to another.

Although embodiments of the present disclosure are described with respect to a WiMAX-compliant radio access technology (RAT), the techniques and apparatus described herein may be easily extended to other RATs. For example, embodiments of the present disclosure may be extended or modified to be used with LTE (Long Term Evolution), UMB (Ultra Mobile Broadband), or other 3G (Third Generation) or pre-4G (pre-Fourth Generation) RATs that support QoS and/or HARQ services.

### Exemplary Wireless Communication System

The techniques described herein may be used for various broadband wireless communication systems, including communication systems that are based on an orthogonal multiplexing scheme. Examples of such communication systems include Orthogonal Frequency Division Multiple Access (OFDMA) systems, Single-Carrier Frequency Division Multiple Access (SC-FDMA) systems, and so forth. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

One example of a communication system based on an orthogonal multiplexing scheme is a WiMAX system. WiMAX, which stands for the Worldwide Interoperability for Microwave Access, is a standards-based broadband wireless technology that provides high-throughput broadband connections over long distances. There are two main applications of WiMAX today: fixed WiMAX and mobile WiMAX. Fixed WiMAX applications are point-to-multipoint, enabling broadband access to homes and businesses, for example. Mobile WiMAX is based on OFDM and OFDMA and offers the full mobility of cellular networks at broadband speeds.

IEEE 802.16x is an emerging standard organization to define an air interface for fixed and mobile broadband wireless access (BWA) systems. These standards define at least four different physical layers (PHYs) and one media access control (MAC) layer. The OFDM and OFDMA physical layer of the four physical layers are the most popular in the fixed and mobile BWA areas respectively.

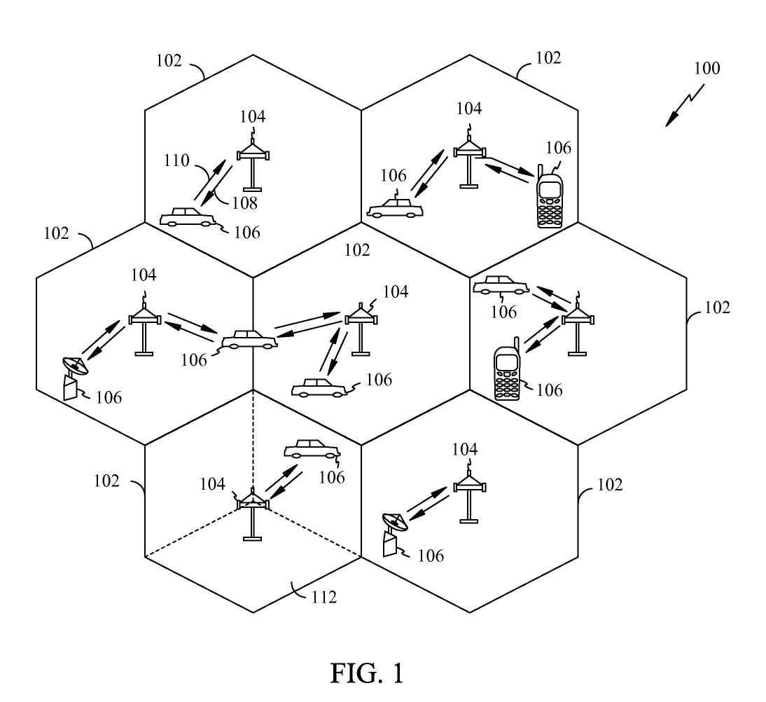

FIG. 1 illustrates an example of a wireless communication system 100. The wireless communication system 100 may be a broadband wireless communication system. The wireless communication system 100 may provide communication for a number of cells 102, each of which is serviced by a base station 104. A base station 104 may be a fixed station that communicates with user terminals 106. The base station 104 may alternatively be referred to as an access point, a Node B, or some other terminology.

FIG. 1 depicts various user terminals 106 dispersed throughout the system 100. The user terminals 106 may be fixed (i.e., stationary) or mobile. The user terminals 106 may alternatively be referred to as remote stations, access terminals, terminals, subscriber units, mobile stations, stations, user equipment, etc. The user terminals 106 may be wireless devices, such as cellular phones, personal digital assistants (PDAs), handheld devices, wireless modems, laptop computers, personal computers (PCs), etc.

A variety of algorithms and methods may be used for transmissions in the wireless communication system 100 between the base stations 104 and the user terminals 106. For example, signals may be sent and received between the base stations 104 and the user terminals 106 in accordance with OFDM/OFDMA techniques. If this is the case, the wireless communication system 100 may be referred to as an OFDM/OFDMA system.

A communication link that facilitates transmission from a base station 104 to a user terminal 106 may be referred to as a downlink 108, and a communication link that facilitates transmission from a user terminal 106 to a base station 104 may be referred to as an uplink 110. Alternatively, a downlink 108 may be referred to as a forward link or a forward channel, and an uplink 110 may be referred to as a reverse link or a reverse channel.

A cell 102 may be divided into multiple sectors 112. A sector 112 is a physical coverage area within a cell 102. Base stations 104 within a wireless communication system 100 may utilize antennas that concentrate the flow of power within a particular sector 112 of the cell 102. Such antennas may be referred to as directional antennas.

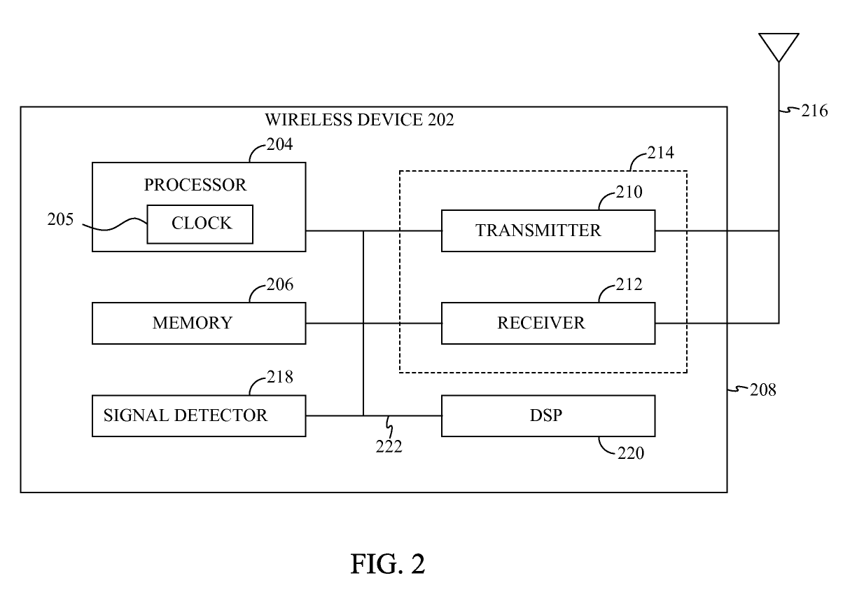

FIG. 2 illustrates various components that may be utilized in a wireless device 202. The wireless device 202 is an example of a device that may be configured to implement the various methods described herein. The wireless device 202 may be a base station 104 or a user terminal 106.

The wireless device 202 may include a processor 204 which controls operation of the wireless device 202. The processor 204 may also be referred to as a central processing unit (CPU). Memory 206, which may include both read-only memory (ROM) and random access memory (RAM), provides instructions and data to the processor 204. A portion of the memory 206 may also include non-volatile random access memory (NVRAM). The processor 204 typically performs logical and arithmetic operations based on program instructions stored within the memory 206. The instructions in the memory 206 may be executable to implement the methods described herein.

The wireless device 202 may also include a housing 208 that may include a transmitter 210 and a receiver 212 to allow transmission and reception of data between the wireless device 202 and a remote location. The transmitter 210 and receiver 212 may be combined into a transceiver 214. An antenna 216 may be attached to the housing 208 and electrically coupled to the transceiver 214. The wireless device 202 may also include (not shown) multiple transmitters, multiple receivers, multiple transceivers, and/or multiple antennas.

The wireless device 202 may also include a signal detector 218 that may be used in an effort to detect and quantify the level of signals received by the transceiver 214. The signal detector 218 may detect such signals as total energy, pilot energy from pilot subcarriers or signal energy from the preamble symbol, power spectral density, and other signals. The wireless device 202 may also include a digital signal processor (DSP) 220 for use in processing signals.

The various components of the wireless device 202 may be coupled together by a bus system 222, which may include a power bus, a control signal bus, and a status signal bus in addition to a data bus.

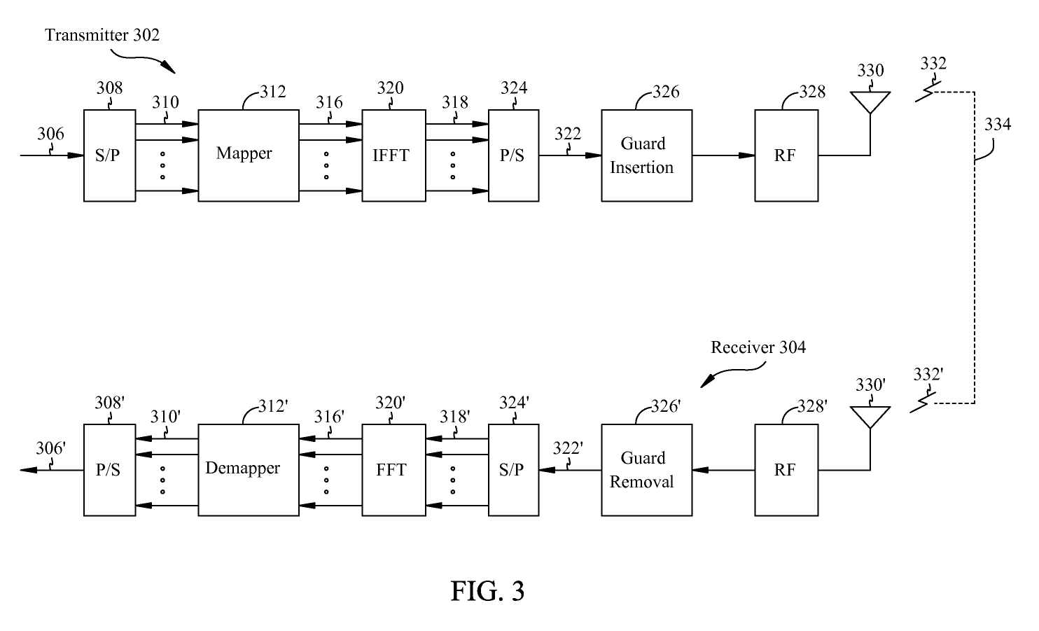

FIG. 3 illustrates an example of a transmitter 302 that may be used within a wireless communication system 100 that utilizes OFDM/OFDMA. Portions of the transmitter 302 may be implemented in the transmitter 210 of a wireless device 202. The transmitter 302 may be implemented in a base station 104 for transmitting data 306 to a user terminal 106 on a downlink 108. The transmitter 302 may also be implemented in a user terminal 106 for transmitting data 306 to a base station 104 on an uplink 110.

Data 306 to be transmitted is shown being provided as input to a serial-to-parallel (S/P) converter 308. The S/P converter 308 may split the transmission data into N parallel data streams 310.

The N parallel data streams 310 may then be provided as input to a mapper 312. The mapper 312 may map the N parallel data streams 310 onto N constellation points. The mapping may be done using some modulation constellation, such as binary phase-shift keying (BPSK), quadrature phase-shift keying (QPSK), 8 phase-shift keying (8PSK), quadrature amplitude modulation (QAM), etc. Thus, the mapper 312 may output N parallel symbol streams 316, each symbol stream 316 corresponding to one of the N orthogonal subcarriers of the inverse fast Fourier transform (IFFT) 320. These N parallel symbol streams 316 are represented in the frequency domain and may be converted into N parallel time domain sample streams 318 by an IFFT component 320.

A brief note about terminology will now be provided. N parallel modulations in the frequency domain are equal to N modulation symbols in the frequency domain, which are equal to N mapping and N-point IFFT in the frequency domain, which is equal to one (useful) OFDM symbol in the time domain, which is equal to N samples in the time domain. One OFDM symbol in the time domain, Nₛ, is equal to N_{cp} (the number of guard samples per OFDM symbol)+N (the number of useful samples per OFDM symbol).

The N parallel time domain sample streams 318 may be converted into an OFDM/OFDMA symbol stream 322 by a parallel-to-serial (P/S) converter 324. A guard insertion component 326 may insert a guard interval between successive OFDM/OFDMA symbols in the OFDM/OFDMA symbol stream 322. The output of the guard insertion component 326 may then be upconverted to a desired transmit frequency band by a radio frequency (RF) front end 328. An antenna 330 may then transmit the resulting signal 332.

FIG. 3 also illustrates an example of a receiver 304 that may be used within a wireless communication system 100 that utilizes OFDM/OFDMA. Portions of the receiver 304 may be implemented in the receiver 212 of a wireless device 202. The receiver 304 may be implemented in a user terminal 106 for receiving data 306 from a base station 104 on a downlink 108. The receiver 304 may also be implemented in a base station 104 for receiving data 306 from a user terminal 106 on an uplink 110.

The transmitted signal 332 is shown traveling over a wireless channel 334. When a signal 332′ is received by an antenna 330′, the received signal 332′ may be downconverted to a baseband signal by an RF front end 328′. A guard removal component 326′ may then remove the guard interval that was inserted between OFDM/OFDMA symbols by the guard insertion component 326.

The output of the guard removal component 326′ may be provided to an S/P converter 324′. The S/P converter 324′ may divide the OFDM/OFDMA symbol stream 322′ into the N parallel time-domain symbol streams 318′, each of which corresponds to one of the N orthogonal subcarriers. A fast Fourier transform (FFT) component 320′ may convert the N parallel time-domain symbol streams 318′ into the frequency domain and output N parallel frequency-domain symbol streams 316′.

A demapper 312′ may perform the inverse of the symbol mapping operation that was performed by the mapper 312, thereby outputting N parallel data streams 310′. A P/S converter 308′ may combine the N parallel data streams 310′ into a single data stream 306′. Ideally, this data stream 306′ corresponds to the data 306 that was provided as input to the transmitter 302.

Exemplary Selection of a Target BS for Handover based on Supported Services

In a mobile WiMAX network, service flows are supposed to be provided by the target BS after a handover procedure is completed. Because different BSs may have different capabilities and the traffic load on each BS may be different, as well, a target BS may not guarantee that all service quality levels can be maintained at the same levels provided by the serving BS. For example, with the current IEEE 802.16e standard, an MS does not know prior to handover whether HARQ-related or QoS-related services provided by the serving BS can be maintained at previous service quality levels once the handover to the target BS is completed. Therefore, in some instances, an MS may suddenly experience longer delay or a strong echo during a Voice over Internet Protocol (VoIP) call, a higher bit error rate for T1/E1 trunk data services, etc.

Accordingly, it may be desirable to notify the MS of the service flow parameters a neighbor BS supports in case none of the neighbor BSs can maintain the service quality levels provided by the serving BS. In this manner, the MS may make a more informed decision when selecting one or more neighbor BS candidates for handover, without being surprised when a target BS cannot support all previously supported services. Certain embodiments of the present disclosure utilize handover messages with the addition of a new field indicating services supported by a neighbor BS to accomplish these objectives.

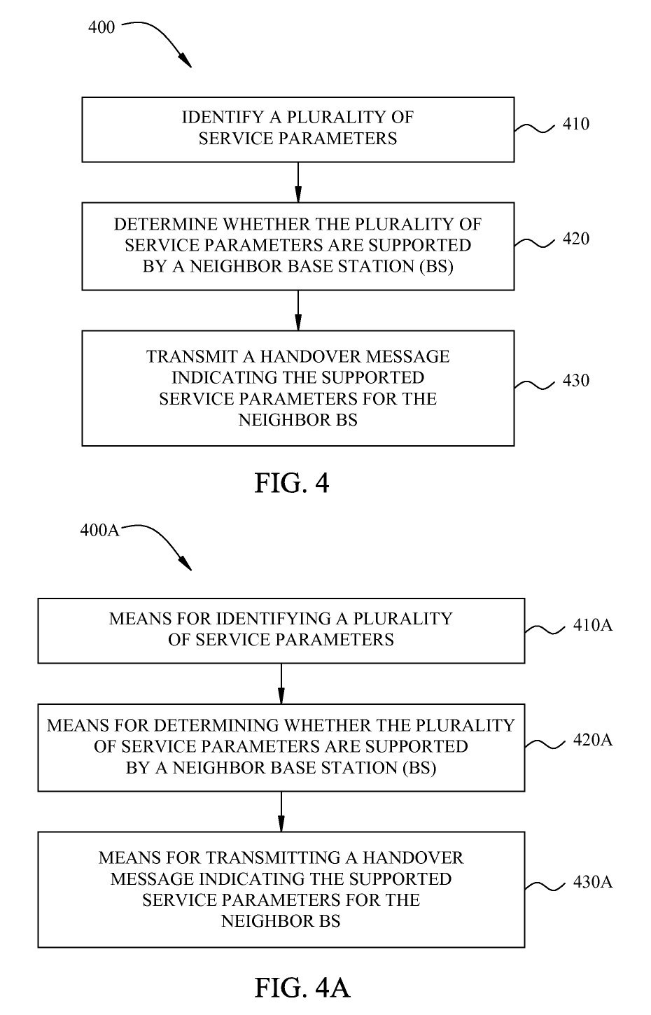

FIG. 4 is a flow diagram of example operations 400 for notifying a mobile station (MS) of service parameters supported by a neighbor base station (BS) from the perspective of a serving BS. The operations 400 may begin, at 410, by identifying a plurality of service parameters. These service parameters may include any suitable configuration parameter of a service flow, such as a quality of service (QoS) parameter or a hybrid automatic repeat-request (HARQ). For example, a QoS service parameter may comprise a minimum reserved traffic rate, a maximum latency, a request/transmission policy, an unsolicited grant interval, a maximum sustained traffic rate, a traffic priority, an unsolicited polling interval, and/or a tolerated jitter. A HARQ service parameter may comprise, for example, a window size, a retry timeout for the transmitter, a retry timeout for the receiver, a block lifetime, a synchronization loss timeout, a deliver-in-order parameter, a purge timeout, a block size, and/or a receiver ARQ acknowledgment processing time.

At 420, the serving BS may determine whether the plurality of service parameters are supported by a neighbor BS. This determination may be made during communications between the serving BS and the neighbor BS via the network backbone.

At 430, the serving BS may transmit a handover message indicating the service parameters supported by the neighbor BS. The handover message may be a BS Handover Request (MOB_BSHO-REQ) message if the serving BS requests the handover. If a mobile station initiates the handover, however, the handover message may be a BS Handover Response (MOB_BSHO-RSP) message. To indicate the supported service parameters, a new field called Service Level Supported may be added to the handover message.

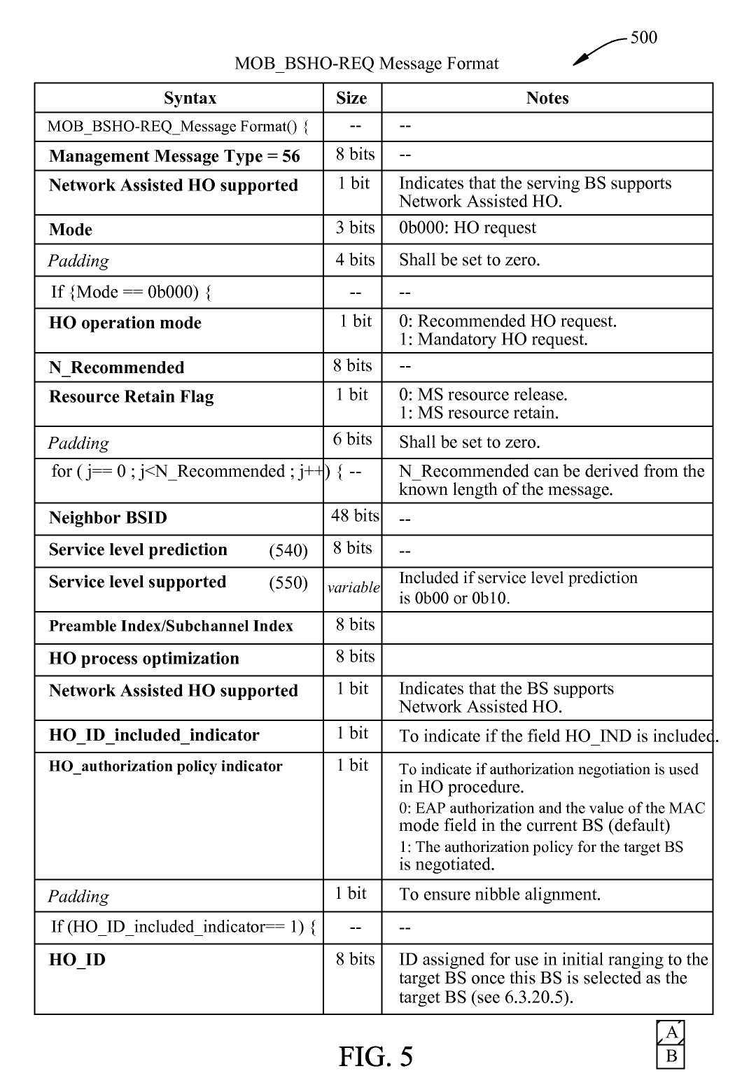

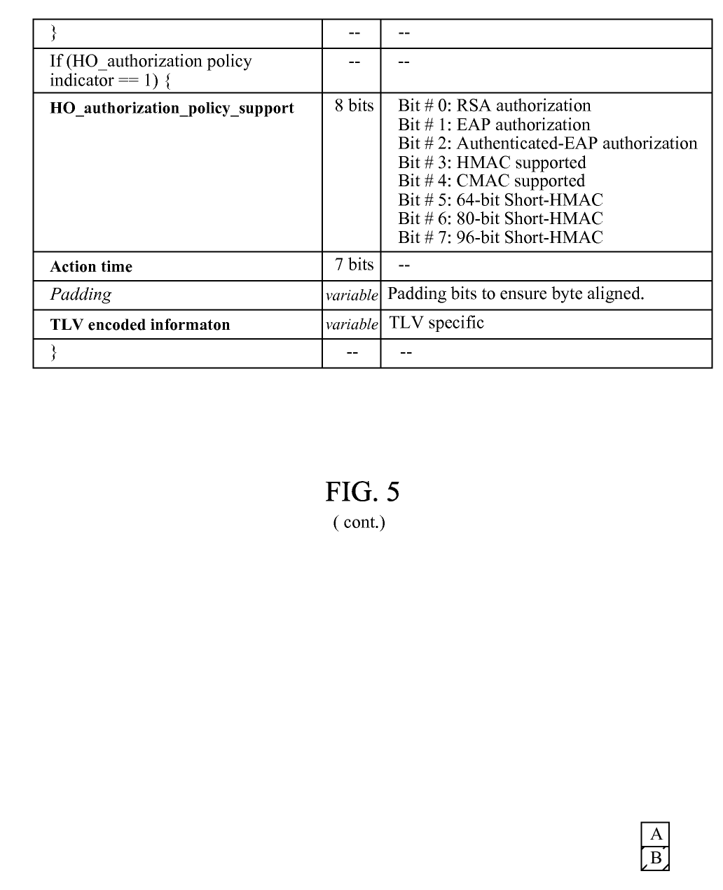

FIG. 5 illustrates an example BS Handover Request (MOB_BSHO-REQ) message format 500 with a Service Level Supported field 550 indicating services supported by respective neighbor BSs, in accordance with certain embodiments of the present disclosure. The MOB_BSHO-REQ message format 500 is specified in the IEEE 802.16e standard, but certain embodiments of the present disclosure may introduce the additional Service Level Supported field 550 after the Service Level Prediction field 540.

For each BS up to the number of recommended neighbor BSs (N_Recommended), the value in the Service Level Prediction field 540 indicates the level of service the MS can expect from this BS. A 0x0 indicates that no service is possible for this MS. A 0x1 indicates that some service is available for one or more service flows authorized for the MS. A 0x2 indicates that for each authorized service flow, a Media Access Control (MAC) connection can be established with QoS specified by the AuthorizedQoSParamSet. A 0x3 indicates that there is no service level prediction available.

The Service Level Supported field 550 may indicate the services that are available for a given neighbor BS. For some embodiments, the Service Level Supported field 550 may be included only if the value in the Service Level Prediction field 540 does not equal 0x0 (0b00) or 0x2 (0b10 in binary). When the Service Level Prediction field 540 does not equal 0x0 or 0x2, this means that the respective neighbor BS can not support all the configuration parameters for each service flow as the serving BS does. Therefore, the Service Level Supported field 550 may indicate just which service parameters the respective neighbor BS can support.

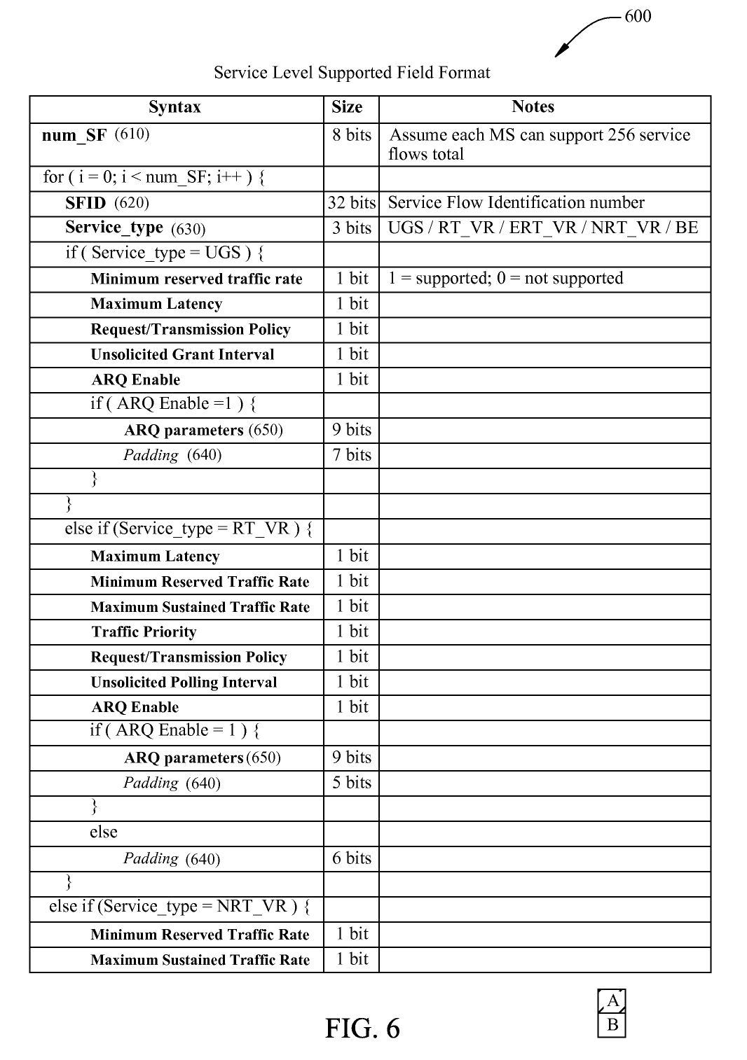

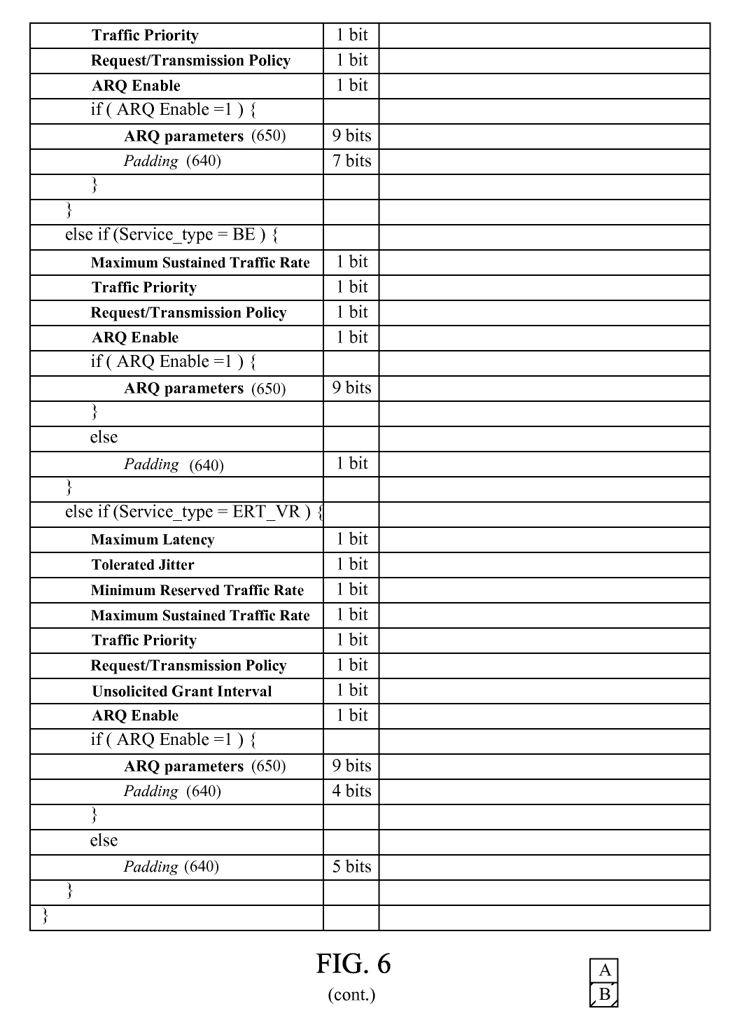

FIG. 6 illustrates an example format 600 of the Service Level Support field 550, illustrating the various service parameters and padding bits for byte alignment. To indicate the supported service parameters, the Service Level Supported field 550 may include an 8-bit (1-byte) num_SF parameter 610 to indicate the number of service flows supported by a given MS, assuming that the maximum number of service flows is 256 (2⁸). Following the num_SF parameter 610, the Service Level Supported field 550 may include a 32-bit (4-byte) Service Flow Identification (SFID) number 620, a 3-bit Service_type parameter 630 to indicate the QoS, and depending on the Service_type parameter 630 and whether HARQ is enabled, either 5 bits or 21 bits of service flow parameter information and any bit padding 640 for byte alignment. Thus, each service flow in the Service Level Supported field 550 has a length of either 1 byte or 3 bytes. Therefore, the Service Level Supported field 550 may have a variable length depending on the number of service flows supported (num_SF) and whether HARQ is enabled, leading to a maximum length of [1+(4+3)*num_SF] bytes. The length of this field may be defined as part of the message or a new TLV (Type Length Value). The Service_type parameter 630 may have a value indicating whether the QoS is Unsolicited Grant Service (UGS), Real-Time Variable Rate (RT-VR), Extended Real-Time Variable Rate (ERT-VR), Non-Real-Time Variable Rate (NRT-VR), or Best-Effort Service (BE).

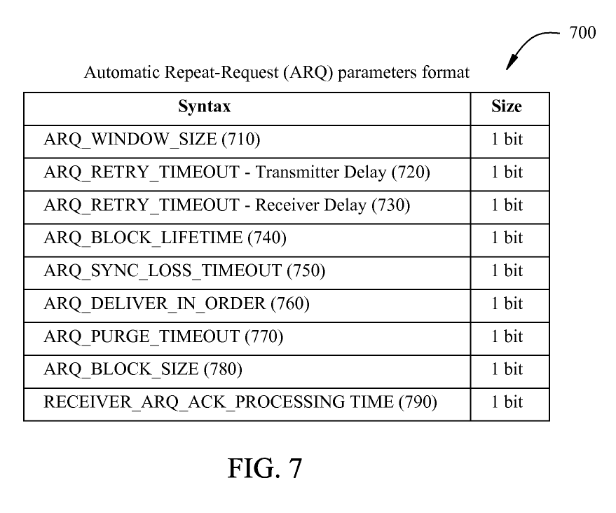

If HARQ is enabled (i.e., ARQ Enable=1) for a particular service flow, the Service Level Supported field 550 may include nine separate Automatic Repeat-Request (ARQ) parameters 650, each having a length of 1 bit to indicate whether that ARQ parameter is supported or not. FIG. 7 illustrates an example format 700 of ARQ parameters 650 as part of the Service Level Supported field 550 of FIG. 6. For example, the ARQ parameters 650 may include any suitable combination in any order of an ARQ_Window_Size 710, an ARQ_Retry_Timeout 720 for transmitter delay, an ARQ_Retry_Timeout 730 for receiver delay, an ARQ_Block_Lifetime 740, an ARQ_Sync_Loss_Timeout 750, an ARQ_Deliver_in_Order 760, an ARQ_Purge Timeout 770, an ARQ_Block_Size 780, and a Receiver_ARQ_ACK_Processing_Time 790.

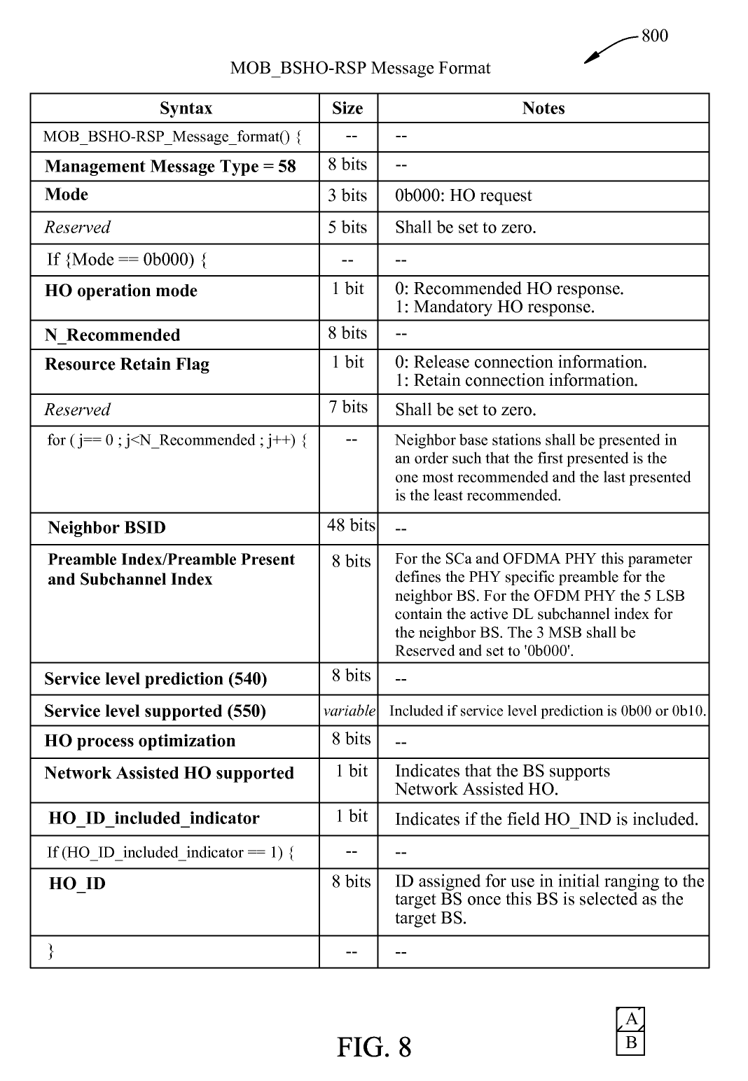

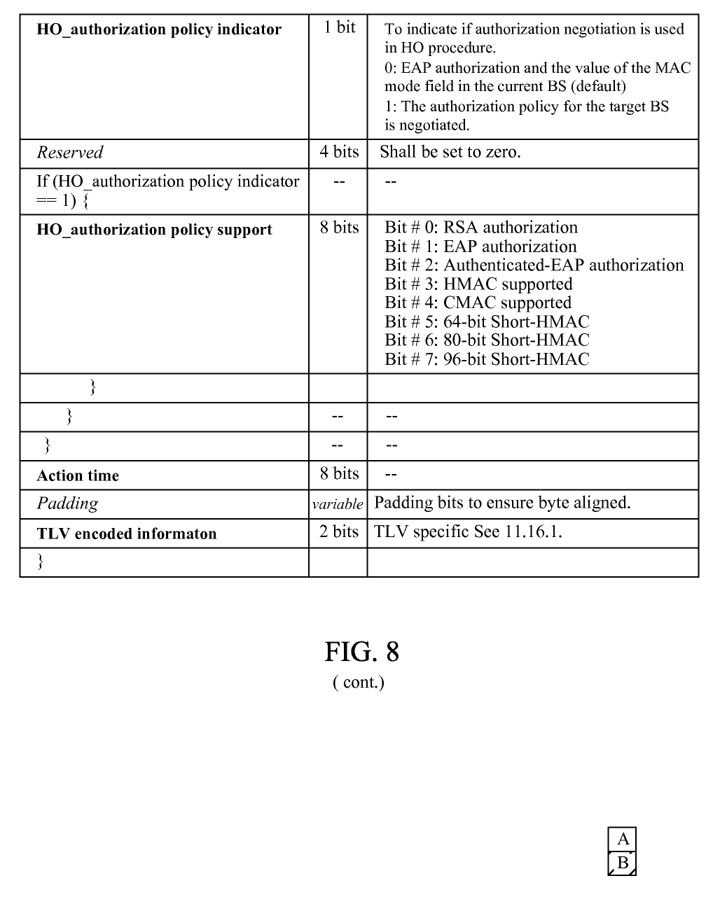

FIG. 8 illustrates a BS Handover Response (MOB_BSHO-RSP) message format 800 with a Service Level Supported field 550 indicating services supported by respective neighbor BSs as described above, in accordance with certain embodiments of the present disclosure. The Service Level Supported field 550 may follow the Service Level Protection field 540 in certain embodiments, as described above. For some embodiments, the Service Level Supported field 550 may be included only if the value in the Service Level Prediction field 540 does not equal 0x0 or 0x2.

By indicating which service parameters respective neighbor BSs can support, the information contained in the Service Level Supported field 550 of the handover message may be used to make the best choice for a target BS from the BS list provided by the serving BS during handover. Furthermore, the MS will not be surprised if QoS and/or HARQ requirements are downgraded when the MS performs a handover to a neighbor BS that cannot support all the service parameters previously supported by the serving BS.

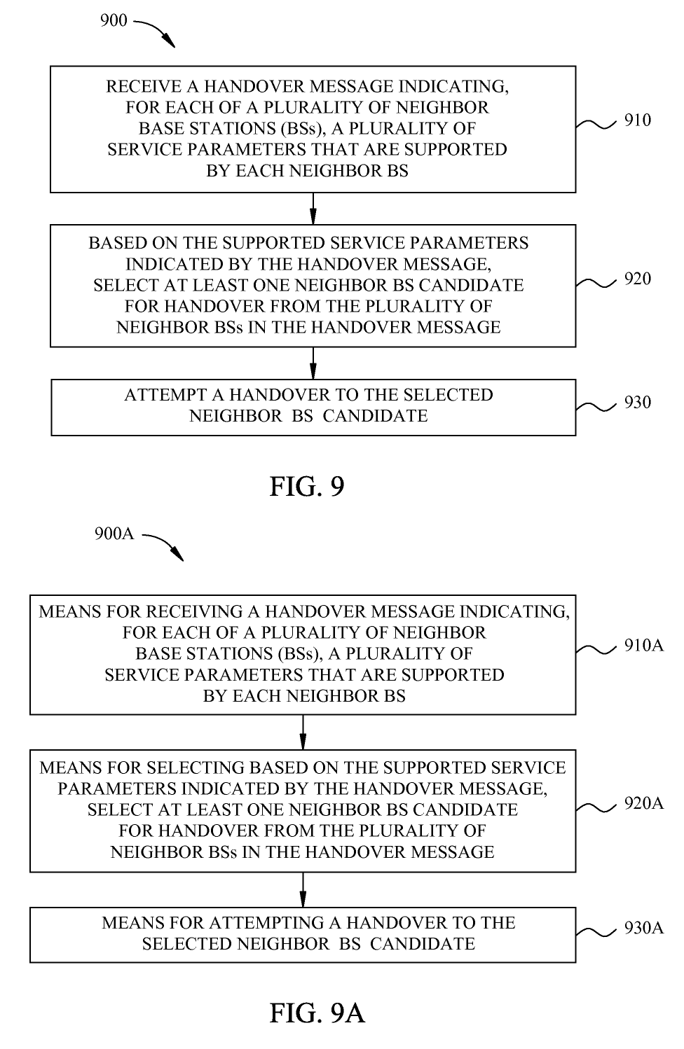

FIG. 9 is a flow diagram of example operations 900 from the perspective of an MS for determining, from among a group of neighbor BSs, at least one neighbor BS candidate for handover based on the service parameters supported by each neighbor BS, in accordance with certain embodiments of the present disclosure. The operations 900 begin, at 910, by receiving a handover message notifying the MS of a plurality of neighbor BSs and indicating a plurality of service parameters that are supported by each neighbor BS. The handover message may be a MOB_BSHO-REQ or MOB_BSHO-RSP with a Service Level Supported field 550, as illustrated in FIG. 5 or FIG. 8, respectively.

Based on the supported service parameters indicated by the handover message, the MS may select at least one neighbor BS candidate for handover from the plurality of neighbor BSs listed in the handover message at 920. At 930, the MS may attempt a handover to the selected neighbor BS candidate.

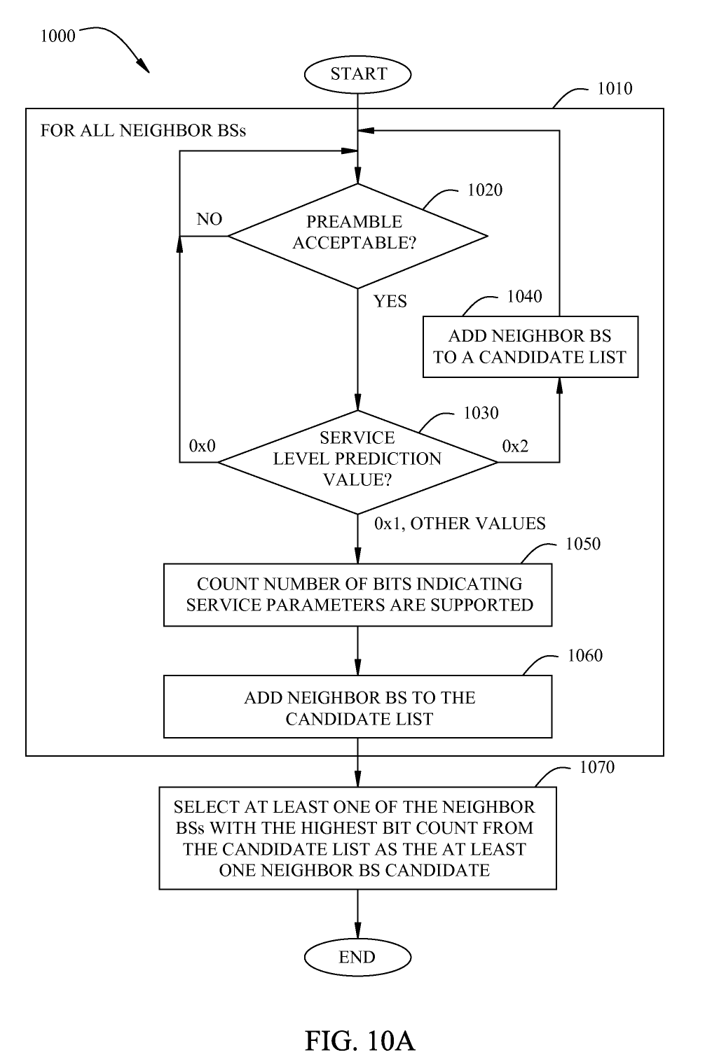

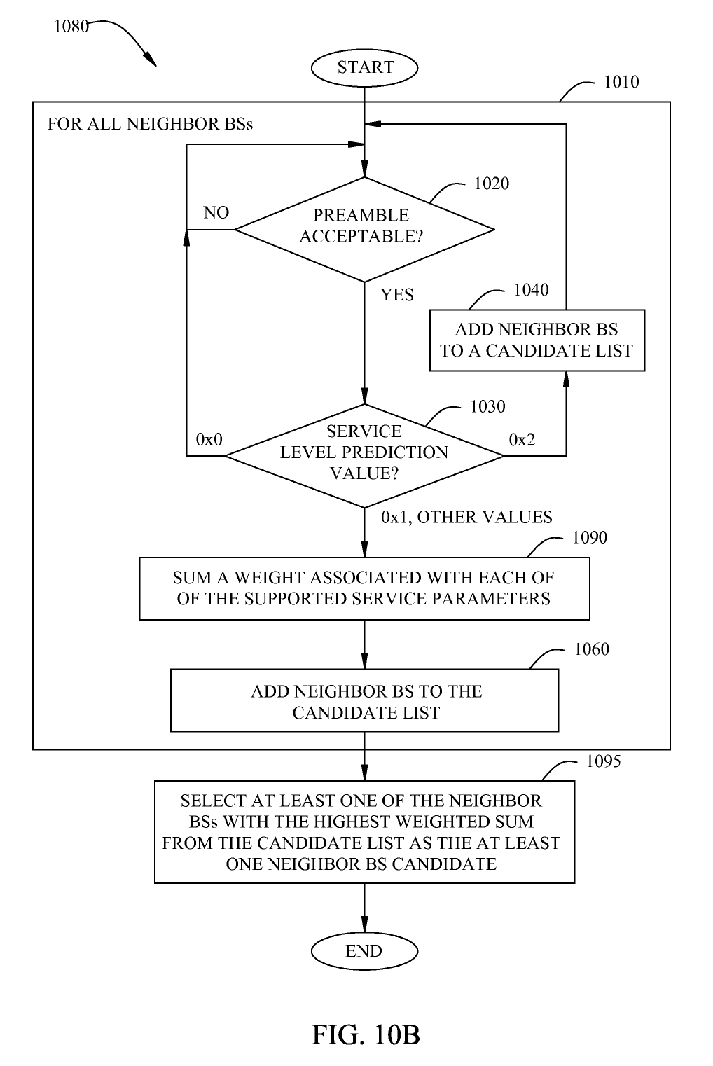

FIG. 10A is a flow diagram of example operations 1000 for selecting at least one neighbor BS candidate for handover based on supported service parameters at 920. For all neighbor BSs listed in the handover message at 1010, the operations 1000 may begin, at 1020, by checking whether the preamble of the neighbor BS is within an acceptable range for the MS. If not, then the next BS may be checked at 1020. If the preamble is acceptable at 1020, then the value of the Service Level Prediction field 540 for the current neighbor BS may be read at 1030.

If the value of the Service Level Prediction field 540 is 0x0 at 1030, then the preamble for the next neighbor BS in the list may be checked at 1020. If the value of the Service Level Prediction field 540 is 0x0 at 1030, then the MS may add the current neighbor BS to a list of neighbor BS candidates for handover (i.e., the candidate list) at 1040. If the value of the Service Level Prediction field 540 is 0x1 or any other value at 1030, then the MS may count a number of bits in the Service Level Supported field 550 indicating that a service parameter is indeed supported by the current neighbor BS. In other words, the MS may count all of the bits set to a value of 1. For some embodiments, the MS may ignore an ARQ Enable bit and/or any padding bits for byte alignment when counting. At 1060, the MS may add the current neighbor BS to the candidate list.

Once all of the neighbor BSs listed in the handover message have been considered at 1010, the MS may select one of the neighbor BSs in the candidate list as the neighbor BS candidate for attempting a handover at 1070. The MS may select one of the neighbor BSs having a Service Level Prediction value of 0x2 as the neighbor BS candidate, since this neighbor BS supports all of the authorized service flows. If there are no neighbor BSs having a Service Level Prediction value of 0x2, then the MS may select one of the neighbor BSs in the candidate list having the highest bit count. For some embodiments, the MS may select two or more neighbor BSs from the candidate list as neighbor BS candidates for attempting a handover, ranking the candidates according to the count of supported service parameters. In this manner, the MS may attempt a handover to the neighbor BS candidate with the highest count at 930. If the attempted handover fails, the MS may attempt a handover to the neighbor BS candidate with the second highest count, and so forth.

For some embodiments, the MS need not consider all of the plurality of neighbor BSs listed in the handover message. For example, once the MS determines that at least one of the neighbor BSs listed has a Service Level Prediction value of 0x2, the MS may ignore any neighbor BSs that do not have a value of 0x2 at 1030 from then on and need not count the number of bits for supported service parameters at 1050 or add such neighbor BSs to the candidate list at 1060. As another example, the MS may add a limited number of neighbor BSs to the candidate list at 1040 or 1060, and once the candidate list is full (i.e., reaches the limit), the MS may select the neighbor BS candidate from the candidate list at 1070 without evaluating the remaining neighbor BSs listed in the handover message.

FIG. 10B is another flow diagram of example operations 1080 for selecting at least one neighbor BS candidate for handover based on supported service parameters at 920. FIG. 10B is similar to FIG. 10A except that instead of counting the number of bits indicating a number of supported service parameters, the MS may associate a weight with each of the service parameters indicated by the Service Level Supported field 550 and sum the weights for the supported service parameters (e.g., the service parameters having a bit value set to 1 in the handover message) for the current neighbor BS being considered at 1090. At 1095, once the neighbor BS candidates have been considered, the MS may select at least one of the neighbor BSs in the candidate list with the highest weighted sum as the one or more neighbor BS candidates for attempting a handover. In this manner, service parameters with greater importance for whatever reason may be given a higher weighting, and the selection of neighbor BS candidate(s) may take this importance into account.

For some embodiments, the MS may determine that the selected neighbor BS candidate(s) cannot meet a specific one of the service parameters that the MS is concerned about. In such cases, the MS may output a warning based on this determination. The warning may comprise a visible message to a user, a symbol or icon on a display, and/or an audible alert, such as a beep or tone.

Exemplary Performance of a Handover based on Selection of a Target BS Using Supported Service Parameters

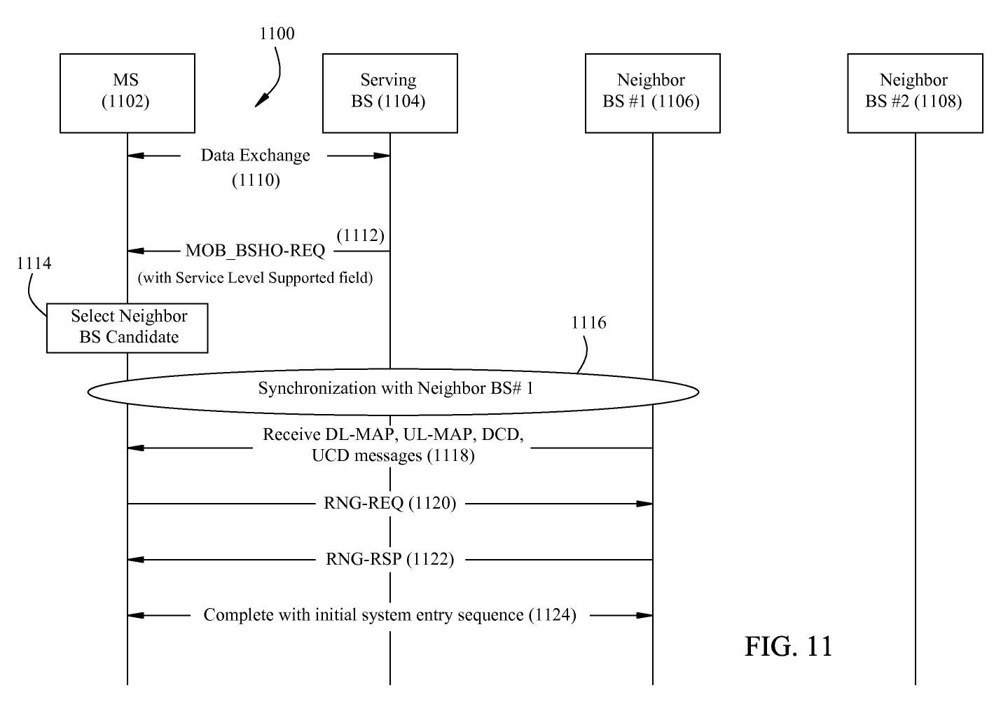

FIG. 11 illustrates an example call flow 1100 for selecting a neighbor BS candidate for handover (i.e., a target BS) based on supported service parameters transmitted to a mobile station (MS) 1102 via a MOB_BSHO-REQ message from a serving base station (BS) 1104 and performing a handover to the target BS. The MS 1102 and the serving BS may be exchanging data at 1110, both in the uplink and the downlink directions.

At some point, the serving BS 1104 may initiate a handover by transmitting a MOB_BSHO-REQ message 1112 with a Service Level Supported field 550 as described above to the MS 1102. The MOB_BSHO-REQ message 1112 may include information about a plurality of neighbor BSs, including neighbor BS #1 (1106) and neighbor BS #2 (1108). This information may indicate whether certain service flow parameters are supported by the neighbor BSs 1106, 1108.

At 1114, the MS 1102 may select one or more neighbor BS candidates for handover from the neighbor BSs listed in the MOB_BSHO-REQ message 1112 as described above with respect to FIG. 9 at 920 and FIG. 10A or 10B. For example, neighbor BS #1 may be selected as the primary target BS. For some embodiments, neighbor BS #2 may be selected as a secondary target BS, should a handover attempt to the primary target BS fail.

At 1116, the MS 1102 may synchronize with the primary target BS, neighbor BS #1. The MS 1102 may receive a downlink MAP (DL-MAP), an uplink MAP (UL-MAP), a downlink channel descriptor (DCD), and an uplink channel descriptor (UCD) broadcast from neighbor BS #1 at 1118. The MS 1102 may send a ranging request (RNG-REQ) message 1120 to the neighbor BS #1, and the neighbor BS #1 may reply with a ranging response (RNG-RSP) message 1122. At 1124, the MS 1102 and the neighbor BS #1 may complete the initial system entry sequence in an effort to complete the handover from the serving BS 1104 to the neighbor BS #1. If the attempted handover fails, the MS may attempt a handover to neighbor BS #2.

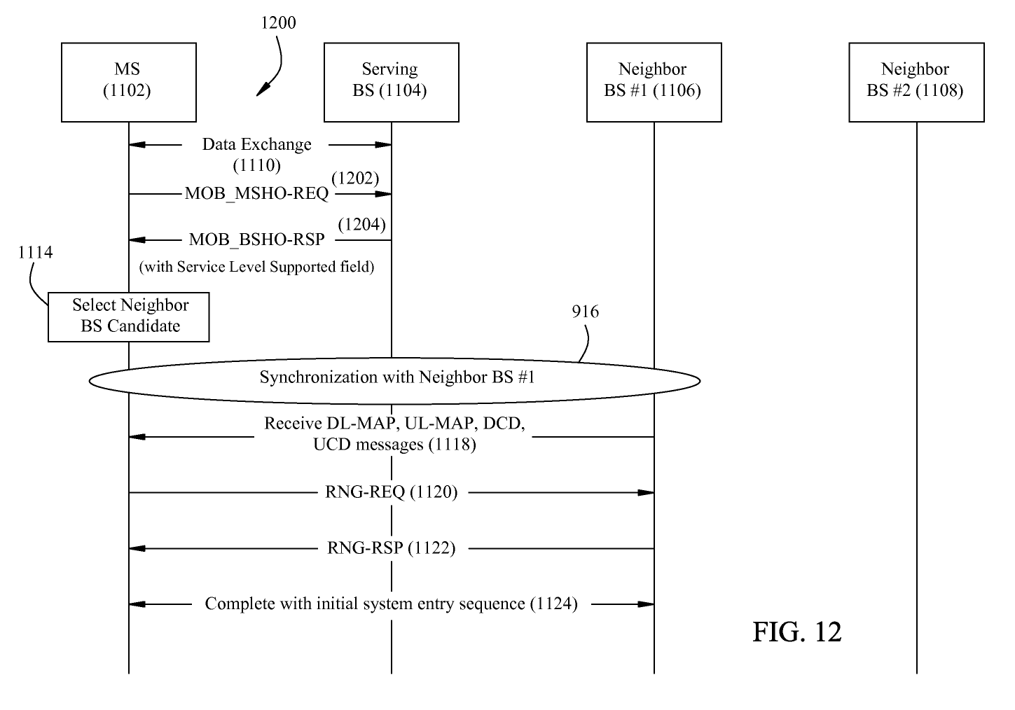

FIG. 12 illustrates another example call flow 1200 for selecting a target BS for handover based on supported service parameters transmitted via a handover message and performing a handover to the target BS. The call flow 1200 in FIG. 12 is similar to the call flow 1100 of FIG. 11, except that the MS 1102 may initiate the handover by transmitting a MOB_BSHO-RSP message 1202 to the serving BS 1104. The serving BS 1104 may respond by transmitting a MOB_MSHO-REQ message 1204 with a Service Level Supported field 550 for at least some of the neighbor BSs listed in the message 1204 as described above.

The various operations of methods described above may be performed by various hardware and/or software component(s) and/or module(s) corresponding to means-plus-function blocks illustrated in the Figures. Generally, where there are methods illustrated in Figures having corresponding counterpart means-plus-function Figures, the operation blocks correspond to means-plus-function blocks with similar numbering. For example, blocks 410-430 illustrated in FIG. 4 correspond to means-plus-function blocks 410A-430A illustrated in FIG. 4A, and blocks 910-930 illustrated in FIG. 9 correspond to means-plus-function blocks 910A-930A illustrated in FIG. 9A.

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

Information and signals may be represented using any of a variety of different technologies and techniques. For example, data, instructions, commands, information, signals, and the like that may be referenced throughout the above description may be represented by voltages, currents, electromagnetic waves, magnetic fields or particles, optical fields or particles, or any combination thereof.

The various illustrative logical blocks, modules, and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components, or any combination thereof designed to perform the functions described herein. A general purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by one or more processors, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM, and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method for indicating supported services of a neighbor base station (BS), comprising:
determining whether a plurality of service parameters are supported by the neighbor BS; and
transmitting a handover message indicating the supported service parameters for the neighbor BS.

2. The method of claim 1, wherein the handover message comprises a Base Station Handover Request (MOB_BSHO-REQ) message.

3. The method of claim 1, further comprising receiving a Mobile Station Handover Request (MSHO-REQ) message, wherein the handover message comprises a Base Station Handover Response (MOB_BSHO-RSP) message.

4. The method of claim 1, wherein the service parameters are Quality of Service (QoS) parameters or Hybrid Automatic Repeat-Request (HARQ) parameters.

5. The method of claim 1, further comprising setting a Service Level Prediction field for the neighbor BS in the handover message to a value other than 0x0 or 0x2, wherein the handover message comprises a Base Station Handover Request (MOB_BSHO-REQ) message or a Base Station Handover Response (MOB_BSHO-RSP) message.

6. The method of claim 5, wherein the supported service parameters are included in a Service Level Supported field for the neighbor BS of the handover message.

7. The method of claim 6, wherein the maximum length of the Service Level Supported field is 1+(4+3)*num_SF bytes and num_SF is a number of service flows for the neighbor BS.

8. The method of claim 1, wherein all of the plurality of service parameters are supported by a serving BS, but not all of the plurality of service parameters are supported by the neighbor BS.

9. The method of claim 1, wherein determining whether the plurality of service parameters are supported by the neighbor BS comprises:
grouping the plurality of service parameters into a plurality of service flows for the neighbor BS; and
determining whether the plurality of service parameters are supported for each of the plurality of service flows for the neighbor BS.

10. A computer-program product for indicating supported services of a neighbor base station (BS), comprising a computer-readable medium having instructions stored thereon, the instructions being executable by one or more processors and the instructions comprising:
instructions for determining whether a plurality of service parameters are supported by the neighbor BS; and
instructions for transmitting a handover message indicating the supported service parameters for the neighbor BS.

11. The computer-program product of claim 10, wherein the handover message comprises a Base Station Handover Request (MOB_BSHO-REQ) message.

12. The computer-program product of claim 10, further comprising instructions for receiving a Mobile Station Handover Request (MSHO-REQ) message, wherein the handover message comprises a Base Station Handover Response (MOB_BSHO-RSP) message.

13. The computer-program product of claim 10, wherein the service parameters are Quality of Service (QoS) parameters or Hybrid Automatic Repeat-Request (HARQ) parameters.

14. The computer-program product of claim 10, further comprising instructions for setting a Service Level Prediction field for the neighbor BS in the handover message to a value other than 0x0 or 0x2, wherein the handover message comprises a Base Station Handover Request (MOB_BSHO-REQ) message or a Base Station Handover Response (MOB_BSHO-RSP) message.

15. The computer-program product of claim 14, wherein the supported service parameters are included in a Service Level Supported field for the neighbor BS of the handover message.

16. The computer-program product of claim 15, wherein the maximum length of the Service Level Supported field is 1+(4+3)*num_SF bytes and num_SF is a number of service flows for the neighbor BS.

17. The computer-program product of claim 10, wherein all of the plurality of service parameters are supported by a serving BS, but not all of the plurality of service parameters are supported by the neighbor BS.

18. The computer-program product of claim 10, wherein the instructions for determining whether the plurality of service parameters are supported by the neighbor BS comprise:
instructions for grouping the plurality of service parameters into a plurality of service flows for the neighbor BS; and
instructions for determining whether the plurality of service parameters are supported for each of the plurality of service flows for the neighbor BS.

19. An apparatus for wireless communications, comprising:
means for determining whether a plurality of service parameters are supported by a neighbor base station (BS); and
means for transmitting a handover message indicating the supported service parameters for the neighbor BS.

20. The apparatus of claim 19, wherein the handover message comprises a Base Station Handover Request (MOB_BSHO-REQ) message.

21. The apparatus of claim 19, further comprising means for receiving a Mobile Station Handover Request (MSHO-REQ) message, wherein the handover message comprises a Base Station Handover Response (MOB_BSHO-RSP) message.

22. The apparatus of claim 19, wherein the service parameters are Quality of Service (QoS) parameters or Hybrid Automatic Repeat-Request (HARQ) parameters.

23. The apparatus of claim 19, further comprising means for setting a Service Level Prediction field for the neighbor BS in the handover message to a value other than 0x0 or 0x2, wherein the handover message comprises a Base Station Handover Request (MOB_BSHO-REQ) message or a Base Station Handover Response (MOB_BSHO-RSP) message.

24. The apparatus of claim 23, wherein the supported service parameters are included in a Service Level Supported field for the neighbor BS of the handover message.

25. The apparatus of claim 24, wherein the maximum length of the Service Level Supported field is 1+(4+3)*num_SF bytes and num_SF is a number of service flows for the neighbor BS.

26. The apparatus of claim 19, wherein all of the plurality of service parameters are supported by the apparatus, but not all of the plurality of service parameters are supported by the neighbor BS.

27. The apparatus of claim 19, wherein the means for determining whether the plurality of service parameters are supported by the neighbor BS comprise:
means for grouping the plurality of service parameters into a plurality of service flows for the neighbor BS; and
means for determining whether the plurality of service parameters are supported for each of the plurality of service flows for the neighbor BS.

28. A base station, comprising:
logic for determining whether a plurality of service parameters are supported by a neighbor base station (BS); and
a transmitter front end configured to transmit a handover message indicating the supported service parameters for the neighbor BS.

29. The base station of claim 28, wherein the handover message comprises a Base Station Handover Request (MOB_BSHO-REQ) message.

30. The base station of claim 28, further comprising a receiver front end configured to receive a Mobile Station Handover Request (MSHO-REQ) message, wherein the handover message comprises a Base Station Handover Response (MOB_BSHO-RSP) message.

31. The base station of claim 28, wherein the service parameters are Quality of Service (QoS) parameters or Hybrid Automatic Repeat-Request (HARQ) parameters.

32. The base station of claim 28, further comprising logic for setting a Service Level Prediction field for the neighbor BS in the handover message to a value other than 0x0 or 0x2, wherein the handover message comprises a Base Station Handover Request (MOB_BSHO-REQ) message or a Base Station Handover Response (MOB_BSHO-RSP) message.

33. The base station of claim 32, wherein the supported service parameters are included in a Service Level Supported field for the neighbor BS of the handover message.

34. The base station of claim 33, wherein the maximum length of the Service Level Supported field is 1+(4+3)*num_SF bytes and num_SF is a number of service flows for the neighbor BS.

35. The base station of claim 28, wherein all of the plurality of service parameters are supported by the base station, but not all of the plurality of service parameters are supported by the neighbor BS.

36. The base station of claim 28, wherein the logic for determining whether the plurality of service parameters are supported by the neighbor BS comprises:
logic for grouping the plurality of service parameters into a plurality of service flows for the neighbor BS; and
logic for determining whether the plurality of service parameters are supported for each of the plurality of service flows for the neighbor BS.

37. A method for determining at least one neighbor base station (BS) candidate for handover, comprising:
receiving a handover message indicating, for each of a plurality of neighbor BSs, a plurality of service parameters that are supported by each neighbor BS; and
based on the supported service parameters indicated by the handover message, selecting the at least one neighbor BS candidate for handover from the plurality of neighbor BSs in the handover message.

38. The method of claim 37, wherein the service parameters are Quality of Service (QoS) parameters or Hybrid Automatic Repeat-Request (HARQ) parameters.

39. The method of claim 37, wherein the handover message comprises a Base Station Handover Request (MOB_BSHO-REQ) message.

40. The method of claim 37, further comprising transmitting a Mobile Station Handover Request (MSHO-REQ) message, wherein the handover message comprises a Base Station Handover Response (MOB_BSHO-RSP) message.

41. The method of claim 37, wherein selecting the at least one neighbor BS candidate comprises determining that a Service Level Prediction parameter for each of the plurality of neighbor BSs does not equal to 0x0 or 0x2, wherein the handover message comprises a Base Station Handover Request (MOB_BSHO-REQ) message or a Base Station Handover Response (MOB_BSHO-RSP) message.

42. The method of claim 41, wherein the service parameters are included in a Service Level Supported field of the handover message for each of the plurality of neighbor BSs.

43. The method of claim 37, wherein selecting the at least one neighbor BS candidate comprises:
for each of the plurality of neighbor BSs, counting a number of bits set to a value of 1 for each of the supported service parameters in the handover message; and
selecting at least one of the plurality of neighbor BSs with the highest bit count as the at least one neighbor BS candidate.

44. The method of claim 43, wherein counting the number of bits set to the value of 1 comprises ignoring an Automatic Repeat-Request (ARQ) Enable bit and any padding bits for byte alignment.

45. The method of claim 37, wherein selecting the at least one neighbor BS candidate comprises:
associating a weight with each of the supported service parameters;
for each of the plurality of neighbor BSs, summing the weights for the supported service parameters having a bit set to a value of 1 in the handover message; and
selecting at least one of the plurality of neighbor BSs with the highest weighted sum as the at least one neighbor BS candidate.

46. The method of claim 45, wherein summing the weights for the supported service parameters having the bit set to the value of 1 comprises ignoring an Automatic Repeat-Request (ARQ) Enable bit and any padding bits for byte alignment.

47. The method of claim 37, further comprising:
determining that the at least one neighbor BS candidate cannot meet a specific one of the service parameters; and
outputting a warning based on the determination.

48. The method of claim 47, wherein the warning comprises at least one of a message, a symbol on a display, and an audible alert.

49. A computer-program product for determining at least one neighbor base station (BS) candidate for handover, comprising a computer-readable medium having instructions stored thereon, the instructions being executable by one or more processors and the instructions comprising:
instructions for receiving a handover message indicating, for each of a plurality of neighbor BSs, a plurality of service parameters that are supported by each neighbor BS; and
instructions for selecting, based on the supported service parameters indicated by the handover message, the at least one neighbor BS candidate for handover from the plurality of neighbor BSs in the handover message.

50. The computer-program product of claim 49, wherein the service parameters are Quality of Service (QoS) parameters or Hybrid Automatic Repeat-Request (HARQ) parameters.

51. The computer-program product of claim 49, wherein the handover message comprises a Base Station Handover Request (MOB_BSHO-REQ) message.

52. The computer-program product of claim 49, further comprising instructions for transmitting a Mobile Station Handover Request (MSHO-REQ) message, wherein the handover message comprises a Base Station Handover Response (MOB_BSHO-RSP) message.

53. The computer-program product of claim 49, wherein the instructions for selecting the at least one neighbor BS candidate comprise instructions for determining that a Service Level Prediction parameter for each of the plurality of neighbor BSs does not equal to 0x0 or 0x2, wherein the handover message comprises a Base Station Handover Request (MOB_BSHO-REQ) message or a Base Station Handover Response (MOB_BSHO-RSP) message.

54. The computer-program product of claim 53, wherein the service parameters are included in a Service Level Supported field of the handover message for each of the plurality of neighbor BSs.

55. The computer-program product of claim 49, wherein the instructions for selecting the at least one neighbor BS candidate comprise:
instructions for counting, for each of the plurality of neighbor BSs, a number of bits set to a value of 1 for each of the supported service parameters in the handover message; and
instructions for selecting at least one of the plurality of neighbor BSs with the highest bit count as the at least one neighbor BS candidate.

56. The computer-program product of claim 55, wherein the instructions for counting the number of bits set to the value of 1 comprise instructions for ignoring an Automatic Repeat-Request (ARQ) Enable bit and any padding bits for byte alignment.

57. The computer-program product of claim 49, wherein the instructions for selecting the at least one neighbor BS candidate comprise:
instructions for associating a weight with each of the supported service parameters;
instructions for summing, for each of the plurality of neighbor BSs, the weights for the supported service parameters having a bit set to a value of 1 in the handover message; and
instructions for selecting at least one of the plurality of neighbor BSs with the highest weighted sum as the at least one neighbor BS candidate.

58. The computer-program product of claim 57, wherein the instructions for summing the weights for the supported service parameters having the bit set to the value of 1 comprise instructions for ignoring an Automatic Repeat-Request (ARQ) Enable bit and any padding bits for byte alignment.

59. The computer-program product of claim 49, further comprising:
instructions for determining that the at least one neighbor BS candidate cannot meet a specific one of the service parameters; and
instructions for outputting a warning based on the determination.

60. The computer-program product of claim 59, wherein the warning comprises at least one of a message, a symbol on a display, and an audible alert.

61. An apparatus for wireless communications, comprising:
means for receiving a handover message indicating, for each of a plurality of neighbor base stations (BSs), a plurality of service parameters that are supported by each neighbor BS; and
means for selecting, based on the supported service parameters indicated by the handover message, at least one neighbor BS candidate for handover from the plurality of neighbor BSs in the handover message.

62. The apparatus of claim 61, wherein the service parameters are Quality of Service (QoS) parameters or Hybrid Automatic Repeat-Request (HARQ) parameters.

63. The apparatus of claim 61, wherein the handover message comprises a Base Station Handover Request (MOB_BSHO-REQ) message.

64. The apparatus of claim 61, further comprising means for transmitting a Mobile Station Handover Request (MSHO-REQ) message, wherein the handover message comprises a Base Station Handover Response (MOB_BSHO-RSP) message.

65. The apparatus of claim 61, wherein the means for selecting the at least one neighbor BS candidate comprise means for determining that a Service Level Prediction parameter for each of the plurality of neighbor BSs does not equal to 0x0 or 0x2, wherein the handover message comprises a Base Station Handover Request (MOB_BSHO-REQ) message or a Base Station Handover Response (MOB_BSHO-RSP) message.

66. The apparatus of claim 65, wherein the service parameters are included in a Service Level Supported field of the handover message for each of the plurality of neighbor BSs.

67. The apparatus of claim 61, wherein the means for selecting the at least one neighbor BS candidate comprise:
means for counting, for each of the plurality of neighbor BSs, a number of bits set to a value of 1 for each of the supported service parameters in the handover message; and
means for selecting at least one of the plurality of neighbor BSs with the highest bit count as the at least one neighbor BS candidate.

68. The apparatus of claim 67, wherein the means for counting the number of bits set to the value of 1 comprise means for ignoring an Automatic Repeat-Request (ARQ) Enable bit and any padding bits for byte alignment.

69. The apparatus of claim 61, wherein the means for selecting the at least one neighbor BS candidate comprise:
means for associating a weight with each of the supported service parameters;
means for summing, for each of the plurality of neighbor BSs, the weights for the supported service parameters having a bit set to a value of 1 in the handover message; and
means for selecting at least one of the plurality of neighbor BSs with the highest weighted sum as the at least one neighbor BS candidate.

70. The apparatus of claim 69, wherein the means for summing the weights for the supported service parameters having the bit set to the value of 1 comprise means for ignoring an Automatic Repeat-Request (ARQ) Enable bit and any padding bits for byte alignment.

71. The apparatus of claim 61, further comprising:
means for determining that the at least one neighbor BS candidate cannot meet a specific one of the service parameters; and
means for outputting a warning based on the determination.

72. The apparatus of claim 71, wherein the warning comprises at least one of a message, a symbol on a display, and an audible alert.

73. A mobile device, comprising:
a receiver front end configured to receive a handover message indicating, for each of a plurality of neighbor base stations (BSs), a plurality of service parameters that are supported by each neighbor BS; and
logic for selecting, based on the supported service parameters indicated by the handover message, the at least one neighbor BS candidate for handover from the plurality of neighbor BSs in the handover message.

74. The mobile device of claim 73, wherein the service parameters are Quality of Service (QoS) parameters or Hybrid Automatic Repeat-Request (HARQ) parameters.

75. The mobile device of claim 73, wherein the handover message comprises a Base Station Handover Request (MOB_BSHO-REQ) message.

76. The mobile device of claim 73, further comprising a transmitter front end configured to transmit a Mobile Station Handover Request (MSHO-REQ) message, wherein the handover message comprises a Base Station Handover Response (MOB_BSHO-RSP) message.

77. The mobile device of claim 73, wherein the logic for selecting the at least one neighbor BS candidate is configured to determine that a Service Level Prediction parameter for each of the plurality of neighbor BSs does not equal to 0x0 or 0x2, wherein the handover message comprises a Base Station Handover Request (MOB_BSHO-REQ) message or a Base Station Handover Response (MOB_BSHO-RSP) message.

78. The mobile device of claim 77, wherein the service parameters are included in a Service Level Supported field of the handover message for each of the plurality of neighbor BSs.

79. The mobile device of claim 73, wherein the logic for selecting the at least one neighbor BS candidate is configured to count, for each of the plurality of neighbor BSs, a number of bits set to a value of 1 for each of the supported service parameters in the handover message and to select at least one of the plurality of neighbor BSs with the highest bit count as the at least one neighbor BS candidate.

80. The mobile device of claim 79, wherein the logic for selecting is configured to count the number of bits set to the value of 1 except an Automatic Repeat-Request (ARQ) Enable bit and any padding bits for byte alignment.

81. The mobile device of claim 73, wherein the logic for selecting the at least one neighbor BS candidate is configured to associate a weight with each of the supported service parameters; sum, for each of the plurality of neighbor BSs, the weights for the supported service parameters having a bit set to a value of 1 in the handover message; and select at least one of the plurality of neighbor BSs with the highest weighted sum as the at least one neighbor BS candidate.

82. The mobile device of claim 81, wherein the logic for selecting the at least one neighbor BS candidate is configured to sum the weights for the supported service parameters having the bit set to the value of 1 except an Automatic Repeat-Request (ARQ) Enable bit and any padding bits for byte alignment.

83. The mobile device of claim 73, further comprising:
logic for determining that the at least one neighbor BS candidate cannot meet a specific one of the service parameters; and
logic for outputting a warning based on the determination.

84. The mobile device of claim 83, wherein the warning comprises at least one of a message, a symbol on a display, and an audible alert.
